(19) United States
(12) Patent Application Publication
(10) Pub. No.: US 2012/0130031 A1
(43) Pub. Date: May 24, 2012

(54) PROCESS FOR THE PREPARATION OF ETHYLENE POLYMERS WITH NARROW MOLECULAR WEIGHT DISTRIBUTION

(75) Inventors: Masaki Fushimi, Eschborn (DE); Dario Liguori, Forino (IT); Tiziano Dall'Occo, Ferrara (IT); Giampiero Morini, Padova (IT); Joachim T.M. Pater, Cocomaro di Focomorto (IT); Gianni Vitale, Ferrara (IT)

(73) Assignee: BASELL POLIOLEFINE ITALIA S.R.I, Milano (IT)

(21) Appl. No.: 13/387,106

(22) PCT Filed: Aug. 2, 2010
(86) PCT No.: PCT/EP10/61212

§ 371 Date: Jan. 25, 2012

Related U.S. Application Data
(60) Provisional application No. 61/274,144, filed on Aug. 13, 2009.

(30) Foreign Application Priority Data
Aug. 6, 2009 (EP) 09167346.7

(51) Int. Cl. C08F 4/76

(52) U.S. Cl. 526/123.1

(57) ABSTRACT

Process for the preparation of ethylene polymers having narrow MWD characterized by a F/E ratio lower than 35 carried out in the presence of a catalyst system comprising (a) a solid catalyst component comprising Ti atoms that are substantially in the +4 oxidation state, Mg, Cl, and optionally OR groups and internal donors in which R is a C1-C20 hydrocarbon group, in which the OR/Ti molar ratio is equal to or lower than 0.35 and the internal donor/Ti ratio is lower than 1, (b) an aluminum alkyl compound and (c) a compound selected from alkoxybenzenes of specified formula.

This application is the U.S. national phase of International Application PCT/EP2010/061212, filed Aug. 2, 2010, claiming priority to European Application 09167346.7 filed Aug. 6, 2009 and the benefit under 35 U.S.C. 119(e) of U.S. Provisional Application No. 61/274,144, filed Aug. 13, 2009; the disclosures of International Application PCT/EP2010/061212, European Application 09167346.7 and U.S. Provisional Application No. 61/274,144, each as filed, are incorporated herein by reference.

The present invention relates to a process for the of polymerization of ethylene and its mixtures with olefins CH₂═CHR, wherein R is an alkyl, cycloalkyl or aryl radical having 1-12 carbon atoms, in order to produce ethylene polymers having narrow molecular weight distribution. The catalyst system used in the process comprises (a) a solid catalyst component comprising Ti, Mg, halogen, optionally specific amounts of OR groups and electron donor, (b) an aluminum alkyl compound and a particular class of aromatic ethers.

The MWD is an important characteristic of ethylene polymers in that it affects both the rheological behavior, and therefore the processability, and the final mechanical properties. In particular, polymers with narrow MWD are suitable for films and injection molding in that deformation and shrinkage problems in the manufactured article are minimized. The width of the molecular weight distribution for the ethylene polymers is generally expressed as melt flow ratio F/E, which is the ratio between the melt index measured by a load of 21.6 Kg (melt index F) and that measured with a load of 2.16 Kg (melt index E). The measurements of melt index are carried out according to ASTM D-1238 and at 190° C.

Catalysts for preparing ethylene (co)polymers having narrow MWD are described in the European patent application EP-A-373999. The catalyst comprises a solid catalyst component consisting of a titanium compound supported on magnesium chloride, an alkyl-Al compound and an electron donor compound (external donor) selected from monoethers of the formula R′OR″. Good results in terms of narrow MWD are only obtained when the solid component also contains an internal electron donor compound (diisobutylphthalate). The catalyst activity is unsatisfactory. This latter characteristic is very important in the operation of the plants because it assures competitiveness of the production plant. Hence, it would be highly desirable to have a catalyst capable to produce polymers with narrow molecular weight distribution, in high yields.

JP 3476056 B2 an ethylene polymerization process in which a catalyst system comprising (A) a solid catalyst component comprising Mg, Ti, OR groups and optionally an electron donor compound, (B) an aluminum alkyl compound and (C) a generic oxygenated organic compound which comprises aliphatic diethers or aromatic mono or poly ether. Due to the preparation used the solid catalyst component has a relatively high amount of OR groups and/or a relatively high amount of internal donor (diisobutylphthalate). As component (c) 1-allyl-3,4-dimethoxybenzene has been used in examples 1-4 while 1,2,3-trimethoxybenzene was used in example 5, and 3,4-dimethoxytoluene was used in examples 6-8. The breath of the MWD is not reported, however, it is strongly influenced by the presence of the OR groups and of the internal donor which also provide a negative influence on the catalyst activity.

U.S. Pat. No. 5,200,502, describes the use of 1,2-alkoxybenzenes as catalyst deactivating agents in connection with the use of TiCl₃ or VCl₃ based catalysts for ethylene/hexene polymerization. The polymers obtained (table III) are characterized by broad molecular weight distribution as evidenced by the Melt flow ratio F/E ranging from 50 to 70.

The applicant has now found that by coupling certain solid catalyst components and certain external donor it is possible to create a catalyst system able to prepare ethylene polymers with narrow molecular weight distribution.

It is therefore an object of the present invention a process for the preparation of ethylene polymers having narrow MWD characterized by a F/E ratio lower than 35 where F/E is the ratio between the melt index measured by a load of 21.6 Kg (melt index F) and that measured with a load of 2.16 Kg (melt index E) at 190° C. according to ASTM D-1238, said process being carried out in the presence of a catalyst system comprising the product obtained by contacting (a) a solid catalyst component comprising Ti atoms that are substantially in the +4 oxidation state, Mg, Cl, and optionally OR groups and internal donors in which R is a C1-C20 hydrocarbon group, in which the OR/Ti molar ratio is equal to or lower than 0.35 and the internal donor/Ti ratio is lower than 1, (b) an aluminum alkyl compound and c) a compound of formula (I) as external donor

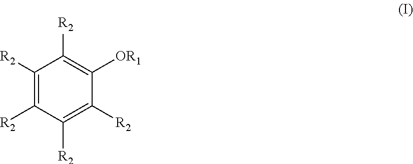

wherein:
R₂, equal to or different from each other, are hydrogen atoms or C₁-C₂₀ hydrocarbon radicals optionally containing heteroatoms belonging to groups 13-17 of the periodic table of the elements or alkoxy groups of formula —OR₁, two or more of the R₂ groups can be connected together to form a cycle; R₁ are C₁-C₂₀ hydrocarbon radicals optionally containing heteroatoms belonging to groups 13-17 of the periodic table of the elements, with the proviso that at least one of R₂ is —OR₁.

In general, it is preferred in the compound (c) of formula (I) that the two —OR₁ groups are in ortho position to each other. Accordingly, 1,2-dialkoxybenenes, 2,3-alkyldialkoxybenzenes or 3,4-alkyldialkoxybenzenes are preferred. The other R₂ groups are preferably selected from hydrogen, C1-C5 alkyl groups and OR₁ groups. When also the other R₂ is an alkoxygroup OR₁, a trialkoxybenzene derivative is obtained and in this case the third alkoxy may be vicinal (ortho) to the other two alkoxy or in meta position with respect to the closest alkoxygroup. Preferably, R₁ is selected from C1-C10 alkyl groups and more preferably from C1-C5 linear or branched alkyl groups. Linear alkyls are preferred. Preferred alkyls are methyl, ethyl, n-propyl, n-butyl and n-pentyl.

When one or more of the other R₂ is a C1-C5 linear or branched alkyl groups, alkyl-alkoxybenzenes are obtained. Preferably, R₂ is selected from methyl or ethyl. According to a preferred embodiment one of the R₂ is methyl and the remaining are hydrogen.

One of the preferred subclasses is that of the dialkoxytoluenes, among this class preferred members are 2,3-dimethoxytoluene, 3,4-dimethoxytoluene, 3,4-diethoxytoluene, 3,4,5 trimethoxytoluene.

When two or more of the R₂ groups are linked to form a cycle, polycyclic alkoxybenzenes are obtained. Among them di- or polyalkoxy naphthalenes optionally substituted with C1-C10 hydrocarbon groups are preferred.

When all the other R₂ groups are hydrogen it is preferred that the R₁ groups are selected from C1-C5 alkyl groups and preferably from methyl, ethyl, and butyl.

In a preferred aspect of the invention the catalyst component (a) comprises a Ti compound having at least one Ti-halogen bond supported on a magnesium chloride which is preferably magnesium dichloride and more preferably magnesium dichloride in active form. In the context of the present application the term magnesium chloride means magnesium compounds having at least one magnesium chloride bond. The magnesium dichloride in the active form is characterized by X-ray spectra in which the most intense diffraction line which appears in the spectrum of the non active chloride (lattice distanced of 2.56 Å) is diminished in intensity and is broadened to such an extent that it becomes totally or partially merged with the reflection line falling at lattice distance (d) of 2.95 Å. When the merging is complete the single broad peak generated has the maximum of intensity which is shifted towards angles lower than those of the most intense line.

Throughout the present application the wording “Ti atoms that are substantially in the +4 oxidation state” means that at least 95% of the Ti atoms have a valence state of 4.

Preferably, the content of Ti atoms with a valence state lower than 4 is less than 0.1% and more preferably they are absent (not detectable with the applied method described below).

The solid catalyst components (a) may in principle comprise an electron donor compound (internal donor), selected among ethers, esters, amines and ketones. However, as already explained, it has been found particularly advantageous for the present invention to include an electron donor compound only in amount such as to give ED/Ti ratios lower than 0.5, preferably lower than 0.3. The catalyst component (A) not including any amount of electron donor compound is the most preferred.

Preferred titanium compounds are the halides or the compounds of formula TiXₙ(OR^{I})₄₋ₙ, where 3.65≦n≦4, X is halogen, preferably chlorine, and R^{I} is C₁-C₁₀ hydrocarbon group. Especially preferred titanium compound is titanium tetrachloride. When present the —OR^{I} groups are preferably selected from the compounds in which R¹ is methyl, ethyl, n-butyl or isopropyl. Ethyl is particularly preferred. The presence of —OR^{I} groups may derive directly from the use of titanium haloalkoxydes or may be the result of the exchange reaction between titanium tetrachloride and other compounds containing alkoxy groups. Preferably, in the catalyst of the present invention at least 70% of the titanium atoms and more preferably at least 90% of them, are in the +4 valence state.

Depending on the preparation process, the final catalyst component may also contain aluminum atoms. In such a case, the Mg/Al molar ratio can range from 1 to 35, preferably from 3 to 30, more preferably from 4 to 20 and most preferably in the range 4-16. When present, the amount of Al is typically higher than 0.5% wt., preferably higher than 1% and more preferably in the range of from 1.2-3.5%. Preferably, the amount of Al is lower than that of Ti

The aluminum may derive from compounds of formula AlClM₂ where M can be, independently, OR¹ groups as defined above or Cl. Preferably the aluminum halide is an aluminum chloride.

In addition to the above mentioned characteristics the solid catalyst component (a) may show a porosity P_{F} determined with the mercury method higher than 0.40 cm³/g and more preferably higher than 0.50 cm³/g usually in the range 0.50-0.80 cm³/g. The total porosity P_{T} can be in the range of 0.50-1.50 cm³/g, particularly in the range of from 0.60 and 1.20 cm³/g, and the difference (P_{T}−P_{F}) can be higher than 0.10 preferably in the range from 0.15-0.50.

The surface area measured by the BET method is preferably lower than 80 and in particular comprised between 10 and 70 m²/g. The porosity measured by the BET method is generally comprised between 0.10 and 0.50, preferably from 0.10 to 0.40 cm³/g.

Preferably, in the catalyst component of the invention the average pore radius value, for porosity due to pores up to 1 μm, is in the range from 650 to 1200 Å.

The particles of solid component have substantially spherical morphology and average diameter comprised between 5 and 150 μm, preferably from 20 to 100 μm and more preferably from 30 to 90 μm. As particles having substantially spherical morphology, those are meant wherein the ratio between the greater axis and the smaller axis is equal to or lower than 1.5 and preferably lower than 1.3.

A method suitable for the preparation of spherical components mentioned above comprises a step (a) in which a compound MgCl₂.mR^{III}OH, wherein 0.3≦m≦1.7 and R^{III} is an alkyl, cycloalkyl or aryl radical having 1-12 carbon atoms is reacted with the said titanium compound of the formula Ti(OR^{I})ₙX₄₋ₙ, in which n, y, X and R^{I} have the same meaning as already defined.

In this case MgCl₂.mR^{III}OH represents a precursor of Mg dihalide. These kind of compounds can generally be obtained by mixing alcohol and magnesium chloride in the presence of an inert hydrocarbon immiscible with the adduct, operating under stirring conditions at the melting temperature of the adduct (100-130° C.). Then, the emulsion is quickly quenched, thereby causing the solidification of the adduct in form of spherical particles. Representative methods for the preparation of these spherical adducts are reported for example in U.S. Pat. No. 4,469,648, U.S. Pat. No. 4,399,054, and WO98/44009. Another useable method for the spherulization is the spray cooling described for example in U.S. Pat. Nos. 5,100,849 and 4,829,034. Adducts having the desired final alcohol content can be obtained by directly using the selected amount of alcohol directly during the adduct preparation. However, if adducts with increased porosity are to be obtained it is convenient to first prepare adducts with more than 1.7 moles of alcohol per mole of MgCl₂ and then subjecting them to a thermal and/or chemical dealcoholation process. The thermal dealcoholation process is carried out in nitrogen flow at temperatures comprised between 50 and 150° C. until the alcohol content is reduced to the value ranging from 0.3 to 1.7. A process of this type is described in EP 395083.

Generally these dealcoholated adducts are also characterized by a porosity (measured by mercury method) due to pores with radius due to pores with radius up to 0.1 μm ranging from 0.15 to 2.5 cm³/g preferably from 0.25 to 1.5 cm³/g.

In the reaction of step (a) the molar ratio Ti/Mg is stoichiometric or higher; preferably this ratio in higher than 3. Still more preferably a large excess of titanium compound is used. Preferred titanium compounds are titanium tetrahalides, in particular TiCl₄. The reaction with the Ti compound can be carried out by suspending the adduct in cold TiCl₄ (generally 0° C.); the mixture is heated up to 80-140° C. and kept at this temperature for 0.5-8 preferably from 0.5 to 3 hours. The excess of titanium compound can be separated at high temperatures by filtration or sedimentation and siphoning.

According to variance of the method, the step (a) is carried out in the presence of an aluminum compound of formula AlCl₂M Where M can be, independently, OR¹ as already defined or chlorine.

The aluminum compound, preferably AlCl₃, which is used in amounts such as to have Mg/Al molar ratio can range from 1 to 35, preferably from 3 to 30, more preferably from 4 to 20 and most preferably in the range 4-16.

The catalyst component (B) used in the process of the invention is selected from Al-alkyl compounds possibly halogenated. In particular, it is selected from Al-trialkyl compounds, for example Al-trimethyl, Al-triethyl, Al-tri-n-butyl, Al-triisobutyl are preferred. The Al/Ti ratio is higher than 1 and is generally comprised between 5 and 800.

The above-mentioned components (A)-(C) can be fed separately into the reactor where, under the polymerization conditions can exploit their activity. It may be advantageous to carry out a pre-contact of the above components, optionally in the presence of small amounts of olefins, for a period of time ranging from 0.1 to 120 minutes preferably in the range from 1 to 60 minutes. The pre-contact can be carried out in a liquid diluent at a temperature ranging from 0 to 90° C. preferably in the range of 20 to 70° C.

The so formed catalyst system can be used directly in the main polymerization process or alternatively, it can be pre-polymerized beforehand. A pre-polymerization step is usually preferred when the main polymerization process is carried out in the gas phase. The prepolymerization can be carried out with any of the olefins CH₂═CHR, where R is H or a C1-C10 hydrocarbon group. In particular, it is especially preferred to pre-polymerize ethylene, propylene or mixtures thereof with one or more α-olefins, said mixtures containing up to 20% in moles of α-olefin, forming amounts of polymer from about 0.1 g per gram of solid component up to about 1000 g per gram of solid catalyst component. The pre-polymerization step can be carried out at temperatures from 0 to 80° C., preferably from 5 to 70° C., in the liquid or gas phase. The pre-polymerization step can be performed in-line as a part of a continuous polymerization process or separately in a batch process. The batch pre-polymerization of the catalyst of the invention with ethylene in order to produce an amount of polymer ranging from 0.5 to 20 g per gram of catalyst component is particularly preferred. The pre-polymerized catalyst component can also be subject to a further treatment with a titanium compound before being used in the main polymerization step. In this case the use of TiCl₄ is particularly preferred. The reaction with the Ti compound can be carried out by suspending the prepolymerized catalyst component in the liquid Ti compound optionally in mixture with a liquid diluent; the mixture is heated to 60-120° C. and kept at this temperature for 0.5-2 hours.

The catalysts of the invention can be used in any kind of polymerization process both in liquid and gas-phase processes. Catalysts having small particle size, (less than 40 μm) are particularly suited for slurry polymerization in an inert medium, which can be carried out continuously stirred tank reactor or in loop reactors. Catalysts having larger particle size are particularly suited for gas-phase polymerization processes which can be carried out in agitated or fluidized bed gas-phase reactors.

As already mentioned, the process of the present invention is suitable for preparing ethylene polymers having narrow molecular weight distribution that are characterized by a F/E ratio equal to or lower than 35 and preferably lower than 30 in combination with a high polymerization activity.

In addition, to the ethylene homo and copolymers mentioned above the catalysts of the present invention are also suitable for preparing very-low-density and ultra-low-density polyethylenes (VLDPE and ULDPE, having a density lower than 0.920 g/cm³, to 0.880 g/cm³) consisting of copolymers of ethylene with one or more alpha-olefins having from 3 to 12 carbon atoms, having a mole content of units derived from ethylene of higher than 80%; elastomeric copolymers of ethylene and propylene and elastomeric terpolymers of ethylene and propylene with smaller proportions of a diene having a content by weight of units derived from ethylene of between about 30 and 70%.

The following examples are given in order to further describe the present invention in a non-limiting manner.

### Characterization

The properties are determined according to the following methods:

### Determination of Ti^{(red)}

0.5 g of the sample in powder form, are dissolved in 100 ml of HCl 2.7M in the presence of solid CO₂. The so obtained solution is then subject to a volumetric titration with a solution of FeNH₄(SO₄)₂.12H₂O 0.1N, in the presence of solid CO₂, using as indicator of the equivalence point NH₄SCN (25% water solution). The stoichiometric calculations based on the volume of the titration agent consumed give the weight amount of Ti³⁺ in the sample.

### Melt Index:

Melt index (M.I.) are measured at 190° C. following ASTM D-1238 over a load of:
2.16 Kg, MI E=MI_{2.16}.
21.6 Kg, MI F=MI_{21.6}.
5 Kg, MI P=MI₅

The ratio: F/E=MI F/MI E=MI_{21.6}/MI_{2.16} is then defined as melt flow ratio (MFR)

The ratio: F/P=MI F/MI P=MI_{21.6}/MI₅ is then defined as melt flow ratio F/P ratio

### MWD.

The molecular weight distribution is also measured by way of Gel Permeation

Chromatography which is carried out according to the method based on DIN 55672 under the following conditions:

Solvent: 1,2,4-trichlorobenzene, flow: 1 ml/min, temperature: 140° C., calibration using PE standards.

### General Procedure (A) for the HDPE Polymerization Test

Into a 1.5 liters stainless steel autoclave, degassed under N₂ stream at 70° C., 500 ml of anhydrous hexane, the reported amount of catalyst component and 0.17 g of triethylaluminum (TEA) were introduced. A molar amount of compound (C) such as to have a molar ratio TEA/donor of 10 The mixture was stirred, heated to 75° C. and thereafter 3 bar of H₂ and 7 bar of ethylene were fed. The polymerization lasted 2 hours. Ethylene was fed to keep the pressure constant. At the end, the reactor was depressurized and the polymer thus recovered was dried under vacuum at 70° C.

### General Procedure (B) for the HDPE Polymerization Test

A 4.5 liter stainless-steel autoclave equipped with a magnetic stirrer, temperature and pressure indicator, feeding line for hexane, ethylene, and hydrogen, was used and purified by fluxing pure nitrogen at 70° C. for 60 minutes. Then, a solution of 1550 cm³ of hexane containing 7.7 cm³ of 10% by wt/vol TEA/hexane was introduced at a temperature of 30° C. under nitrogen flow. In a separate 200 cm³ round bottom glass bottle were successively introduced, 50 cm³ of anhydrous hexane, 1 cm³ of 10% by wt/vol TEA/hexane solution, predefined amount of a solution of the donor component in hexane and 0.040÷0.070 g of the solid catalyst. The added amount of donor is such to have a molar ratio Al/donor equal 10, referred to total amount of added aluminum alkyl. They were mixed together, aged 10 minutes at room temperature and introduced under nitrogen flow into the reactor. The autoclave was closed, then the temperature was raised to 85° C., hydrogen (3 bars partial pressure) and ethylene (7.0 bars partial pressure) were added.

Under continuous stirring, the total pressure was maintained at 85° C. for 120 minutes by feeding ethylene. At the end the reactor was depressurised and the temperature was dropped to 30° C. The recovered polymer was dried at 70° C. under a nitrogen flow and analyzed.

### EXAMPLES 1-5 AND COMPARISON EXAMPLE 1

### Preparation of the Solid Component (A)

A magnesium chloride and alcohol adduct containing about 3 mols of alcohol was prepared following the method described in example 2 of U.S. Pat. No. 4,399,054, but working at 2000 RPM instead of 10000 RPM. The adduct were subject to a thermal treatment, under nitrogen stream, over a temperature range of 50-150° C. until a weight content of 25% of alcohol was reached.

Into a 2 L four-necked round flask, purged with nitrogen, 1 L of TiCl₄ was introduced at 0° C. Then, at the same temperature, 70 g of a spherical MgCl₂/EtOH adduct containing 25% wt of ethanol and prepared as described above were added under stirring. The temperature was raised to 140° C. in 2 h and maintained for 60 min. Then, the stirring was discontinued, the solid product was allowed to settle and the supernatant liquid was siphoned off. The solid residue was then washed once with heptane at 80° C. and five times with hexane at 25° C. and dried under vacuum at 30° C. and analyzed. All the titanium atoms were in the +4 oxidation state and the OEt/Ti molar ratio was 0.12.

Into a 260 cm³ glass reactor provided with stirrer, 351.5 cm³ of hexane at 20° C. and whilst stirring 7 g of the catalyst prepared as above described were introduced at 20° C. Keeping constant the internal temperature, 5.6 cm³ of tri-n-octylaluminum (TNOA) in hexane (about 370 g/l) were slowly introduced into the reactor and the temperature was brought to 10° C. After 10 minutes stirring, 10 g of propylene were carefully introduced into the reactor at the same temperature during a time of 4 hours. The consumption of propylene in the reactor was monitored and the polymerization was discontinued when a theoretical conversion of 1 g of polymer per g of catalyst was deemed to be reached. Then, the whole content was filtered and washed three times with hexane at a temperature of 20° C. (50 g/l). After drying the resulting pre-polymerized catalyst (a) was analyzed and found to contain 1.1 g of polypropylene per g of catalyst.

The pre-polymerized solid catalyst component (A) was employed in the ethylene polymerization according to the general procedure (A) using the type of compound (C) reported in table 1 together with the polymerization results.

### EXAMPLE 6 AND COMPARISON 2

The solid catalyst component (A) prepared as described in example 16 of WO2008/077770 was employed in the ethylene polymerization according to the general procedure (A) using the type of compound (C) reported in table 1 together with the polymerization results.

TABLE 1

| | | Activity | | | |
|---|---|---|---|---|---|
| EX. | Comp. (C) | (g/g) | MIE | F/E | Mw/Mn |
| 1 | TMB | 8137 | 0.43 | 26 | 5.9 |
| 2 | DMB | 6186 | 0.15 | 25 | 7.7 |
| 3 | DEB | 8204 | 0.29 | 26 | 5.6 |
| 4 | DBB | 8507 | 0.36 | 26 | 5.7 |
| 5 | MEB | 5504 | 0.16 | 24 | 6.8 |
| 6 | DPB | 12000 | 0.54 | 22 | 8.4 |
| Comp. 1 | — | 14400 | 0.55 | 34 | 9.9 |
| Comp. 2 | — | 15145 | 1.2 | 33 | 9.6 |

TMB = 1,2,3-trimethoxybenzene
DMB = 1,2-dimethoxybenzene
DEB = 1,2-diethoxybenzene
DBB = 1,2-dibutoxybenzene
MEB = 1-methoxy,-2-ethoxy-benzene
DPB = 1,2-dipropoxybenzene

### EXAMPLES 7-14 AND COMPARISON EXAMPLE 3

### Preparation of the Spherical Support (Adduct MgCl₂/EtOH)

A magnesium chloride and alcohol adduct was prepared following the method described in example 2 of U.S. Pat. No. 4,399,054, but working at 2000 RPM instead of 10000 RPM. The adduct containing about 3 mols of alcohol and 3.1% wt of H₂O and had an average size of about 70 μm.

The adduct were subject to a thermal treatment, under nitrogen stream, over a temperature range of 50-150° C. until a weight content of 25% of alcohol was reached.

Into a 1.5 L reaction vessel, purged with nitrogen, 1 L of TiCl₄ was introduced at 25° C. and cooled at 0° C. Then, at the same temperature, 100 g of a spherical MgCl₂/EtOH adduct containing 25% wt of ethanol and prepared as described above were added under stirring.

The temperature was raised to 130° C. in 90 minutes and then decreased to 80° C. Maintaining the temperature at 80° C., 12.5 g of anhydrous AlCl₃ were added under stirring. The temperature was again increased to 135° C. in 40 minutes and maintained under continuous stirring for 5 hours. Then the temperature was decreased to 90° C., stirring was discontinued, the solid product was allowed to settle for 30 min. and the supernatant liquid was siphoned off. The solid residue was then washed seven times with hexane at 60° C., then dried under vacuum at 30° C. and analyzed. All the titanium atoms were in the +4 oxidation state and the OEt/Ti molar ratio was 0.15.

The solid catalyst component (A) was employed in the ethylene polymerization according to the general procedure (B) using the type of compound (C) reported in table 2 together with the polymerization results.

TABLE 2

| | | Activity | | | |
|---|---|---|---|---|---|
| EX. | Comp. (C) | (g/g) | MIE | F/P | F/E |
| 7* | DMB | 12500 | 0.23 | 9.1 | 26.5 |
| 8 | 1,2,4-TMB | 11000 | 0.11 | 9.7 | 28.2 |
| 9 | TMB | 17300 | 0.15 | 9.0 | 28.7 |
| 109 | ADMB | 13200 | 0.1 | 8.3 | 24.0 |
| 11 | DMT | 18500 | 0.37 | 9.0 | 28.1 |
| 12* | 3.4-DMT | 15400 | 0.21 | 9.4 | 27.6 |
| 13 | TMT | 18600 | 0.17 | 9.4 | 26.5 |
| 14 | DMN | 15200 | <0.1 | 8.2 | |
| Comp. 3 | — | 26600 | 0.4 | 11.1 | 39.0 |

TMB = 1,2,3-trimethoxybenzene
DMB = 1,2-dimethoxybenzene
1.3-DMB = 1,3-dimethoxybenzene
1,2,4-TMB = 1,2,4-trimethoxybenzene
ADMB = 4-allyl,1,2dimethoxybenzene
DMT = 2,3-dimethoxytoluene
3.4-DMT = 3,4-dimethoxytoluene
TMT = 3,4,5-trimethoxytoluene
DMN = 2,3-dimethoxynaphtalene
*In polymerization, 4 bars of hydrogen were used instead of 3 bars.

1. A process for the preparation of ethylene polymers having an F/E ratio lower than 35 where F/E is the ratio between the melt index measured by a load of 21.6 Kg (melt index F) and that measured with a load of 2.16 Kg (melt index E) at 190° C. according to ASTM D-1238, said process being carried out in the presence of a catalyst system comprising the product obtained by contacting (a) a solid catalyst component comprising Ti atoms that are substantially in the +4 oxidation state, Mg, Cl, and optionally OR groups and internal donors wherein R is a C1-C20 hydrocarbon group, wherein the OR/Ti molar ratio is equal to, or lower, than 0.35 and the internal donor/Ti ratio is lower than 1, (b) an aluminum alkyl compound and (c) a compound of formula (I) as external donor 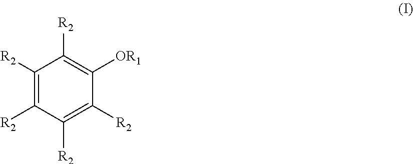
wherein:
R₂, equal to or different from each other, are hydrogen atoms or C₁-C₂₀ hydrocarbon radicals optionally containing heteroatoms belonging to groups 13-17 of the periodic table of the elements or alkoxy groups of formula —OR₁, two or more of the R₂ groups can be connected together to form a cycle; and R₁ equal or different from each other are C₁-C₂₀ hydrocarbon radicals optionally containing heteroatoms belonging to groups 13-17 of the periodic table of the elements, with the proviso that at least one of R₂ is —OR₁.

2. The process according to claim 1 wherein in the compound (c) of formula (I) the two —OR₁ groups are in ortho position to each other.

3. The process according to claim 2 wherein the compound (c) is selected from 1,2 dialkoxybenzenes, 2,3 alkyldialkoxybenzenes or 3,4 alkyldialkoxybenzenes.

4. The process according to claim 1 wherein in the compound (c) of formula (I) the other R₂ groups are selected from hydrogen, C1-C5 alkyl groups and OR₁ groups.

5. The process according to claim 4 wherein the other R₂ is an alkoxygroup OR₁.

6. The process according to claim 1 wherein in the compound (c), R₁ is selected from C1-C10 alkyl groups.

7. The process according to claim 6 wherein R₁ is selected from C1-C5 linear or branched alkyl groups.

8. The process according to claim 4 wherein the other R₂ is a C1-C5 linear or branched alkyl group.

9. The process according to claim 8 wherein R₂ is selected from methyl or ethyl.

10. The process according to claim 9 wherein one of the R₂ is methyl and the remaining are hydrogen.

11. The process according to claim 4 wherein at least two of the other R₂ groups are linked to form a cycle.
